(19) United States
(12) Patent Application Publication
(10) Pub. No.: US 2009/0083332 A1
(43) Pub. Date: Mar. 26, 2009

(54) TAGGING OVER TIME: REAL-WORLD IMAGE ANNOTATION BY LIGHTWEIGHT METALEARNING

(75) Inventors: Ritendra Datta, State College, PA (US); Dhiraj Joshi, Rochester, NY (US); Jia Li, State College, PA (US); James Z. Wang, State College, PA (US)

Correspondence Address: GIFFORD, KRASS, SPRINKLE,ANDERSON & CITKOWSKI, P.C, PO BOX 7021, TROY, MI, 48007-7021, US

(73) Assignee: The Penn State Research Foundation, University Park, PA (US)

(21) Appl. No.: 12/234,159

(22) Filed: Sep. 19, 2008

Related U.S. Application Data
(60) Provisional application No. 60/974,286, filed on Sep. 21, 2007.

(51) Int. Cl. G06F 17/30

(52) U.S. Cl. 707/104.1; 707/E17.001

(57) ABSTRACT

A principled, probabilistic approach to meta-learning acts as a go-between for a ‘black-box’ image annotation system and its users. Inspired by inductive transfer, the approach harnesses available information, including the black-box model's performance, the image representations, and a semantic lexicon ontology. Being computationally ‘lightweight.’ the meta-learner efficiently re-trains over time, to improve and/or adapt to changes. The black-box annotation model is not required to be re-trained, allowing computationally intensive algorithms to be used. Both batch and online annotation settings are accommodated. A “tagging over time” approach produces progressively better annotation, significantly outperforming the black-box as well as the static form of the meta-learner, on real-world data.

### REFERENCE TO RELATED APPLICATION

This application claims priority from U.S. Provisional Patent Application Ser. No. 60/974,286, filed Sep. 21, 2007, the entire content of which is incorporated herein by reference.

### GOVERNMENT SUPPORT

This invention was made with government support under Contract Nos. 0347148 and 0705210 awarded by the National Science Foundation. The government has certain rights in the invention.

### FIELD OF THE INVENTION

This invention relates generally to automated image annotation and, more particularly to a meta-learning framework for image tagging and an online environment whereby images and user tags enter the system as a temporal sequence to incrementally train the meta-learner over time to progressively improve annotation performance and adapt to changing user-system dynamics.

### BACKGROUND OF THE INVENTION

The scale of the World Wide Web makes it essential to have automated systems for content management. A significant fraction of this content exists in the form of images, often with meta-data unusable for meaningful search and organization. To this end, automatic image annotation or tagging is an important step toward achieving large-scale organization and retrieval.

In the recent years, many new image annotation ideas have been proposed. Typical scenarios considered are those where batches of images, having visual semblance with training images, are statically tagged. However, incorporating automatic image tagging into real-world photo-sharing environments (e.g., Flickr, Riya, Photo.Net) poses unique challenges that have seldom been taken up in the past.

In an online setting, where people upload images, automatic tagging needs to be performed as and when they are received, to make them searchable by text. On the other hand, people often collaboratively tag a subset of the images from time to time, which can be leveraged for automatic annotation. Moreover, time can lead to changes in user-focus/user-base, resulting in continued evolution of user tag vocabulary, tag distributions, or topical distribution of uploaded images.

In online systems, e.g., Yahoo! and Flickr, collaborative image tagging, also referred to as folksonomic tagging, plays a key role in making the image collections organizable by semantics and searchable by text. This effort can go a long way if automated image annotation engines complement the human tagging process, taking advantage of these tags and addressing the inherent scalability issues associated with human-driven processes.

Traditionally, annotation engines have considered the batch setting, whereby a fixed-size dataset is used for training, following which it is applied to a set of test images, in the hope of generalization. A realistic embedding of such an engine into an online setting must tackle three main issues: (1) Current state-of-the-art in annotation is a long way off from being reliable on real-world data. (2) Image collections in online systems are dynamic in nature—over time, new images are uploaded, old ones are tagged, etc.

Annotation engines have traditionally been trained on fixed image collections tagged using fixed vocabularies, which severely constrain adaptability over time. (3) While a solution may be to re-train the annotation engine with newly acquired images, most proposed methods are too computationally intensive to re-train frequently. None of the questions associated with image annotation in an online setting, such as (a) how often to re-train, (b) with what performance gain, and (c) at what cost, have been answered in the annotation literature. A recently proposed system, Alipr, incorporates automatic tagging into its photo-sharing framework, but it still is limited by the above issues.

From a machine-learning point of view, the main difference is in the nature by which ground-truth is made available (FIG. 1). The batch setting (left) is what has traditionally been conceived in the annotation literature, whereby the entire ground-truth is available at once, with no intermittent user-feedback. The online setting (right) is an abstracted representation of how an automated annotation system can be incorporated into a public-domain photo-sharing environment. As discussed, this setting poses challenges which have largely not been previously dealt with.

### SUMMARY OF THE INVENTION

One aspect of this invention is directed to a principled, lightweight, meta-learning framework for image tagging. With very few simplifying assumptions, the framework can be built atop any available annotation engine that we refer to as the ‘black-box’. Experimentally, we find that such an approach can dramatically improve annotation performance over the black-box system in a batch setting (and thus make it more viable for real-world implementation), incurring insignificant computational overhead for training and annotation.

A second aspect of the invention resides in an online setting, whereby images and user tags enter the system as a temporal sequence, as in the case of Flickr and Alipr. Here, a tagging over time (T/T) approach is used that incrementally trains the meta-learner over time to progressively improve annotation performance and adapt to changing user-system dynamics, without the need to re-train the (computationally intensive) annotation engine. Some advantages include the following:
A meta-learning framework for annotation, based on inductive transfer, is disclosed, and shown to dramatically boost performance in batch and online settings.
The meta-learning framework is designed in a way that makes it lightweight for re-training and inferencing in an online setting, by making the training process deterministic in time and space consumption.
Appropriate smoothing steps are introduced to deal with sparsity in the meta-learner training data.
Two different re-training models, persistent memory and transient memory, are disclosed.

They are realized through simple incremental/decremental learning steps, and the intuitions behind them are experimentally validated.

Experiments are conducted by building the meta-learner atop two annotation engines, using the popular Corel dataset, and two real-world image traces and user-feedback obtained from the Alipr system. Empirically, various intuitions about the meta-learner and the T/T framework are tested.

### BRIEF DESCRIPTION OF THE DRAWINGS

FIG. 1 shows batch and online image annotation settings;

FIG. 2 shows meta-learner training framework for annotation;

FIG. 3 shows a visualization of Pr(G_{w}_{ᵢ}=gᵢ|A_{w}_{ⱼ}=1, G_{w}_{ⱼ}=0);

FIG. 4 shows a schematic overview of ‘tagging over time’;

FIGS. 5A to 5D show the precision and F₁-score comparisons for traces #1 and #2;

FIGS. 6A and 6B show the precision & F₁-score for mem. model comparison;

FIGS. 7A and 7B show F₁-score and time with varying Lᵢₙₜᵣₑ; and

FIG. 8 shows sample annotation results, improving over time.

### DETAILED DESCRIPTION OF THE INVENTION

### Related Work

Research in automatic image annotation can be roughly categorized into two different ‘schools of thought’: (1) Words and visual features are jointly modeled to yield compound predictors describing an image or its constituent regions. The words and image representations used could be disparate or single vectored representations of text and visual features. (2)

Automatic annotation is treated as a two-step process consisting of supervised image categorization, followed by word selection based on the categorization results. While the former approaches can potentially label individual image regions, ideal region annotation would require precise image segmentation, an open problem in computer vision. Although the latter techniques cannot label regions, they are typically more scalable to large image collections.

The term meta-learning has historically been used to describe the learning of meta-knowledge about learned knowledge. Research in meta-learning covers a wide spectrum of approaches and applications, as has been reviewed in. Here, we briefly discuss the approaches most pertinent to this work. One of the most popular meta-learning approaches, boosting is widely used in supervised classification. Boosting involves iteratively adjusting weights assigned to data points during training, to adaptively reduce misclassification. In stacked generalization, weighted combinations of responses from multiple learners are taken to improve overall performance. The goal here is to learn optimal weights using validation data, in the hope of generalization to unseen data.

A research area under the meta-learning umbrella that is closest to our work is inductive transfer/transfer learning. Research in inductive transfer is grounded on the belief that knowledge assimilated about certain tasks can potentially facilitate the learning of certain other tasks. Incrementally learning support vectors as and when training data is encountered has been explored as a scalable supervised learning procedure. In our work, we draw inspiration from inductive transfer and incremental/decremental learning to develop the meta-learner and the overall T/T framework.

### Meta-Learning

Given an image annotation system or algorithm, we treat it as a ‘black-box’ and build a lightweight meta-learner that attempts to understand the performance of the system on each word in its vocabulary, taking into consideration all available information, which includes:

Annotation performance of the black-box models.

Ground-truth annotation/tags, whenever available.

External knowledge bases, e.g., WordNet.

Visual content of the images.

Here, we discuss the nature of each one, and formulate a probabilistic framework to harness all of them. We consider a black-box system that takes an image as input and guesses one or more words as its annotation. We do not concern ourselves directly with the methodology or philosophy the black-box employs, but care about their output. A ranked ordering of the guesses is not necessary for our framework, but can be useful for empirical comparison.

Assume that either there is ground-truth readily available for a subset of the images, or, in an online setting, images are being uploaded and collaboratively/individually tagged from time to time, which means that ground-truth is made available as and when users tag them. For example, consider that an image is uploaded but not tagged. At this time, the black-box can make guesses at its annotation. At a later time, user provide tags to it, at which point it becomes clear how good the black-box's guesses were. This is where the meta-learner fits in, in an online scenario. The images are also available to the meta-learner for visual content analysis. Furthermore, knowledge bases (e.g., WordNet) can be potentially useful, since semantics recognition is the desiderata of annotation.

### Generic Framework

Let the black-box annotation system be known to have a word vocabulary denoted by V_{bbox}. Let us denote the ground-truth vocabulary by V_{gtruth}. The meta-learner works on the union of these vocabularies, namely V=(V_{bbox}∪V_{gtruth})={w₁, . . . , wₖ}, where K=|V|, the size of this overall vocabulary. Given an image I, the black-box predicts a set of words to be its correct annotation. To denote these guesses, we introduce indicator variables G_{w}ε{0, 1}, wεV, where a value of 1 or 0 indicates whether word wᵢ is predicted by the black-box for 1 or not. We introduce similar indicator variables A_{w}ε{0, 1}, wεV to denote the ground-truth tagging, where a value of 1 or 0 indicates whether w is a correct annotation for 1 or not. Strictly speaking, we can conceive the black-box as a multi-valued function ƒ_{bbox} mapping an image I to indicator variables G_{w}_{ᵢ}: ƒ_{bbox}(I)=(G_{w}_{₁}, . . . , G_{w}_{ₖ}) Similarly, the ground-truth labels can be thought of as a function ƒ_{gtruth} mapping the image to its true labels using the indicator variables: ƒ_{gtruth}(I)=(A_{w}_{₁}, . . . , A_{w}_{ₖ}).

Regardless of the abstraction of visual content that the black-box uses for annotation, the pixel-level image representation may be still available to the meta-learner. If some visual features extracted from the images represent a different abstraction than what the black-box uses, they can be thought of as a different viewpoint and thus be potentially useful for semantics recognition. Such a visual feature representation, that is also simple enough not to add significant computational overhead, can be thought of as a function defined as: ƒᵥᵢₛ(I)=(h₁, . . . , h_{D}). Here, we specify a D-dimensional image feature vector representation as an example. Instead, other non-vector representations (e.g., variable-length region-based features) can also be used as long as they are efficient to compute and process, so as to keep the meta-learner lightweight.

Finally, the meta-learner also has at its disposal an external knowledge base, namely the semantic lexicon WordNet, which is essentially a semantic lexicon for the English language that has in the past been found useful for image annotation. The invention is not limited in this regard, however, insofar as other and yet to be developed lexicons may be used. In particular, WordNet-based semantic relatedness measures have benefited annotation tasks. WordNet, however, does not include most proper nouns and colloquial words that are often prevalent in human tag vocabularies. Such non-WordNet words must therefore be ignored or eliminated from the vocabulary V in order to use WordNet on the entire vocabulary. The meta-leamer attempts to assimilate useful knowledge from this lexicon for performance gain.

It can be argued that this semantic knowledge base may help discover the connection between the true semantics of images, the guesses made by the black-box model for that image, and the semantic relatedness among the guesses. Once again, the inductive transfer idea comes into play, whereby we conjecture that the black-box, with its ability to recognize semantics of some image classes, may help recognize the semantics of entirely different classes of images. Let us denote the side-information extracted (externally) from the knowledge base and the black-box guesses for an image by a numerical abstraction, namely ƒ_{kbase}(I)=(ρ₁, . . . , ρ_{K}), where ρᵢεR, with the knowledge base and the black-box guesses implicitly conditioned.

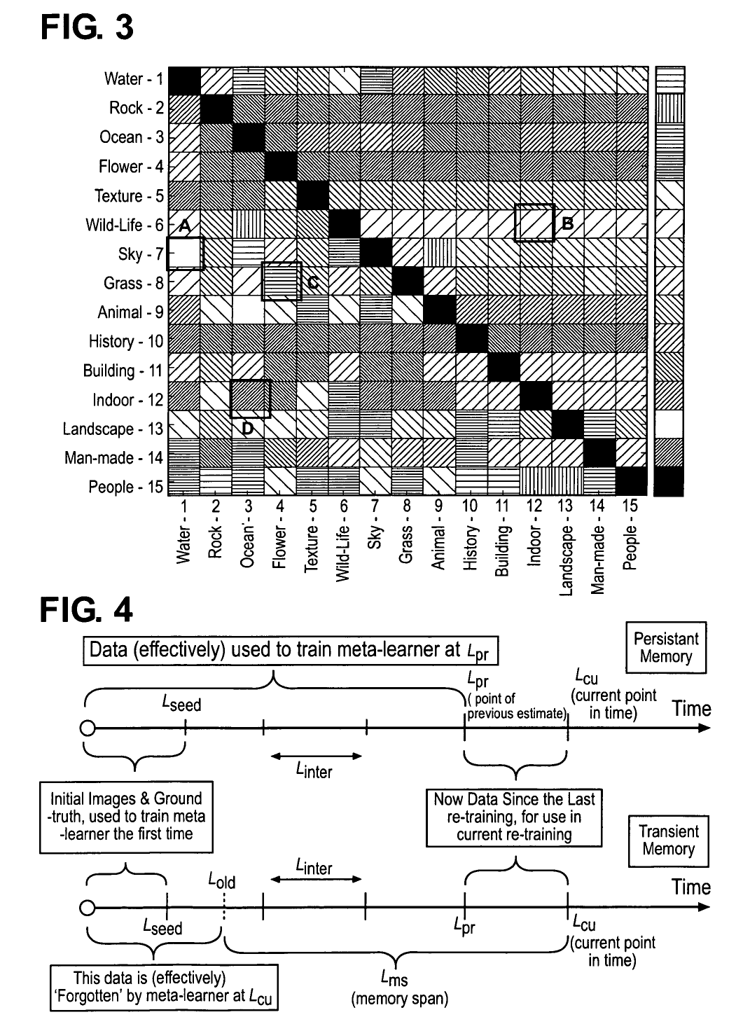

We are now ready to postulate a probabilistic formulation for the meta-learner. In essence, this meta-learner, trained on available data with feedback (see FIG. 2), acts a function which takes in all available information pertaining to an image I, including the black-box's annotation, and produces a new set of guesses as its annotation. In our meta-learner, this function is realized by taking decisions on each word independently. In order to do so, we compute the following odds in favor of each word wⱼ to be an actual ground-truth tag, given all pertinent information, as follows:

$${l}_{{w}_{j}} ( I ) = \frac{Pr ( {A}_{{w}_{j}} = 1 \vert {f}_{bbox} ( I ) , {f}_{kbase} ( I ) , {f}_{vis} ( I ) )}{Pr ( {A}_{{w}_{j}} = 0 \vert Pr ( {f}_{bbox} ( I ) , {f}_{kbase} ( I ) , {f}_{vis} ( I ) )} \qquad ( 1 )$$

Note that here ƒbbox(I) (and similarly, the other terms) denotes a realization of the corresponding random variables given the image I. Using Bayes' Rule, we can re-write:

$${l}_{{w}_{j}} ( I ) = \frac{Pr ( {A}_{{w}_{j}} = 1 \vert {f}_{bbox} ( I ) , {f}_{kbase} ( I ) , {f}_{vis} ( I ) )}{Pr ( {f}_{bbox} ( I ) , {f}_{kbase} ( I ) , {f}_{vis} ( I ) )} \times \frac{Pr ( {f}_{bbox} ( I ) , {f}_{kbase} ( I ) , {f}_{vis} ( I ) )}{Pr ( {A}_{{w}_{j}} = 0 , {f}_{bbox} ( I ) , {f}_{kbase} ( I ) , {f}_{vis} ( I ) )} = \frac{Pr ( {A}_{{w}_{j}} = 1 , {f}_{bbox} ( I ) , {f}_{kbase} ( I ) , {f}_{vis} ( I ) )}{Pr ( {A}_{{w}_{j}} = 0 , {f}_{bbox} ( I ) , {f}_{kbase} ( I ) , {f}_{vis} ( I ) )} \qquad ( 2 )$$

In ƒ_{bbox}(I), if the realization of variable G_{w}_{ᵢ} for each word wᵢ is denoted by gᵢε{0,1} given I, then without loss of generality, for each j, we can split ƒ_{bbox}(I) as follows:

$${f}_{bbox} ( I ) = ( {G}_{{w}_{j}} = {g}_{j} , {⋃}_{i \neq j} ( {G}_{{w}_{i}} = {g}_{i} ) ) \qquad ( 3 )$$

We now evaluate the joint probability in the numerator and denominator of l_{w}_{ⱼ} separately, using Eq. 3. For a realization aⱼε{0,1} of the random variable A_{w}_{ᵢ}, we can factor the joint probability (using the chain rule of probability) into a prior and a series of conditional probabilities, as follows:

$$Pr ( {A}_{{w}_{j}} = {a}_{j} , {f}_{bbox} ( I ) , {f}_{kbase} ( I ) , {f}_{vis} ( I ) ) = Pr ( {G}_{{w}_{j}} = {g}_{j} ) \times Pr ( {A}_{{w}_{j}} = {a}_{j} \vert {G}_{{w}_{j}} = {g}_{j} ) \times Pr ( {⋃}_{i \neq j} ( {G}_{{w}_{i}} = {g}_{i} ) \vert {A}_{{w}_{j}} = {a}_{j} , {G}_{{w}_{j}} = {g}_{j} ) \times Pr ( {f}_{kbase} ( I ) \vert {⋃}_{i \neq j} ( {G}_{{w}_{i}} = {g}_{i} ) , {A}_{{w}_{j}} = {a}_{j} , {G}_{{w}_{j}} = {g}_{j} ) \times Pr ( {f}_{vis} ( I ) \vert {f}_{kbase} ( I ) , {⋃}_{i \neq j} ( {G}_{{w}_{i}} = {g}_{i} ) , {A}_{{w}_{j}} = {a}_{j} , {G}_{{w}_{j}} = {g}_{j} ) \qquad ( 4 )$$

The odds in Eq. 1 can now be factored using Eq. 2 and 4:

$${l}_{{w}_{j}} ( I ) = \frac{Pr ( {A}_{{w}_{j}} = 1 \vert {G}_{{w}_{j}} = {g}_{j} )}{Pr ( {A}_{{w}_{j}} = 0 \vert {G}_{{w}_{j}} = {g}_{j} )} \times \frac{Pr ( {⋃}_{i \neq j} ( {G}_{{w}_{i}} = {g}_{i} ) \vert {A}_{{w}_{j}} = 1 , {G}_{{w}_{j}} = {g}_{j} )}{Pr ( {⋃}_{i \neq j} ( {G}_{{w}_{i}} = {g}_{i} ) \vert {A}_{{w}_{j}} = 0 , {G}_{{w}_{j}} = {g}_{j} )} \times \frac{Pr ( {f}_{kbase} ( I ) \vert {A}_{{w}_{j}} = 1 , {⋃}_{i \neq j} ( {G}_{{w}_{i}} = {g}_{i} ) , {G}_{{w}_{j}} = {g}_{j} )}{Pr ( {f}_{kbase} ( I ) \vert {A}_{{w}_{j}} = 0 , {⋃}_{i \neq j} ( {G}_{{w}_{i}} = {g}_{i} ) , {G}_{{w}_{j}} = {g}_{j} )} \times \frac{Pr ( {f}_{vis} ( I ) \vert {A}_{{w}_{j}} = 1 , {f}_{kbase} ( I ) , {⋃}_{i \neq j} ( {G}_{{w}_{i}} = {g}_{i} ) , {G}_{{w}_{j}} = {g}_{j} )}{Pr ( {f}_{vis} ( I ) \vert {A}_{{w}_{j}} = 0 , {f}_{kbase} ( I ) , {⋃}_{i \neq j} ( {G}_{{w}_{i}} = {g}_{i} ) , {G}_{{w}_{j}} = {g}_{j} )} \qquad ( 5 )$$

Note that the ratio of priors

$$\frac{Pr ( {G}_{{w}_{j}} = {g}_{j} )}{Pr ( {G}_{{w}_{j}} = {g}_{j} )} = 1 ,$$

and hence is eliminated. The ratio

$$\frac{Pr ( {A}_{{w}_{j}} = 1 \vert {G}_{{w}_{j}} = {g}_{j} )}{Pr ( {A}_{{w}_{j}} = 0 \vert {G}_{{w}_{j}} = {g}_{j} )}$$

is a sanity check on the black-box for each word. For G_{w}_{ⱼ}=1, it can be paraphrased as “Given that word wⱼ is guessed by the black-box for I, what are the odds of it being correct?”. Naturally, a higher odds indicates that the black-box has greater precision in guesses (i.e., when wⱼ is guessed, it is usually correct). A similar paraphrasing can be done for G_{w}_{ᵢ}=0, where higher odds implies lower word-specific recall in the black-box guesses. A good annotation system should be able to achieve independently (word-specific) and collectively (overall) good precision and recall. These probability ratios therefore give the meta-learner indications about the black-box model's performance for each word in the vocabulary.

When gⱼ=1, the ratio

$$\frac{Pr ( {⋃}_{i \neq j} ( {G}_{{w}_{i}} = {g}_{i} ) \vert {A}_{{w}_{j}} = 1 , {G}_{{w}_{j}} = {g}_{j} )}{Pr ( {⋃}_{i \neq j} ( {G}_{{w}_{i}} = {g}_{i} ) \vert {A}_{{w}_{j}} = 0 , {G}_{{w}_{j}} = {g}_{j} )}$$

in Eq. 5 relates each correctly/wrongly guessed word wⱼ to how every other word wᵢ, i≠j is guessed by the black-box. This component has strong ties with the concept of co-occurrence popular in the language modeling community, the difference being that here it models the word co-occurrence of the black-box's outputs with respect to ground-truth. Similarly, for gⱼ=0, it models how certain words do not co-occur in the black-box's guesses, given the ground-truth. Since the meta-leamer makes decisions about each word independently, it is intuitive to separate them out in this ratio as well. That is, the question of whether word wᵢ is guessed or not, given that another word wⱼ is correctly/wrongly guessed, is treated independently. Furthermore, efficiency and robustness become major issues in modeling joint probability over a large number of random variables, given limited data. Considering these factors, we assume the guessing of each word wᵢ conditionally independent of each other, given a correctly/wrongly guessed word wⱼ, leading to the following approximation:

$$Pr ( {⋃}_{i \neq j} ( {G}_{{w}_{i}} = {g}_{i} ) \vert {A}_{{w}_{j}} = {a}_{j} , {G}_{{w}_{j}} = {g}_{j} ) \approx {\prod }_{i \neq j} Pr ( {G}_{{w}_{i}} = {g}_{i} \vert {A}_{{w}_{j}} = {a}_{j} , {G}_{{w}_{j}} = {g}_{j} ) \qquad ( 6 )$$

The ratio can then be written as

$$\frac{Pr ( {⋃}_{i \neq j} ( {G}_{{w}_{i}} = {g}_{i} ) \vert {A}_{{w}_{j}} = 1 , {G}_{{w}_{j}} = {g}_{j} )}{Pr ( {⋃}_{i \neq j} ( {G}_{{w}_{i}} = {g}_{i} ) \vert {A}_{{w}_{j}} = 0 , {G}_{{w}_{j}} = {g}_{j} )} = {\prod }_{i \neq j} \frac{Pr ( {G}_{{w}_{i}} = {g}_{i} \vert {A}_{{w}_{j}} = 1 , {G}_{{w}_{j}} = {g}_{j} )}{Pr ( {G}_{{w}_{i}} = {g}_{i} \vert {A}_{{w}_{j}} = 0 , {G}_{{w}_{j}} = {g}_{j} )} \qquad ( 7 )$$

The problem of conditional multi-word co-occurrence modeling has been effectively transformed into that of pairwise co-occurrences, which is attractive in terms of modeling, representation, and efficiency. While co-occurrence really happens when gᵢ=gⱼ=1, the other combinations of values can also be useful, e.g., how the frequency of certain word pairs not being both guessed differs according to the correctness of these guesses. The usefulness of component ratios of this product to meta-learning, namely

$$\frac{Pr ( {G}_{{w}_{i}} = {g}_{i} \vert {A}_{{w}_{j}} = 1 , {G}_{{w}_{j}} = {g}_{j} )}{Pr ( {G}_{{w}_{i}} = {g}_{i} \vert {A}_{{w}_{j}} = 0 , {G}_{{w}_{j}} = {g}_{j} )} ,$$

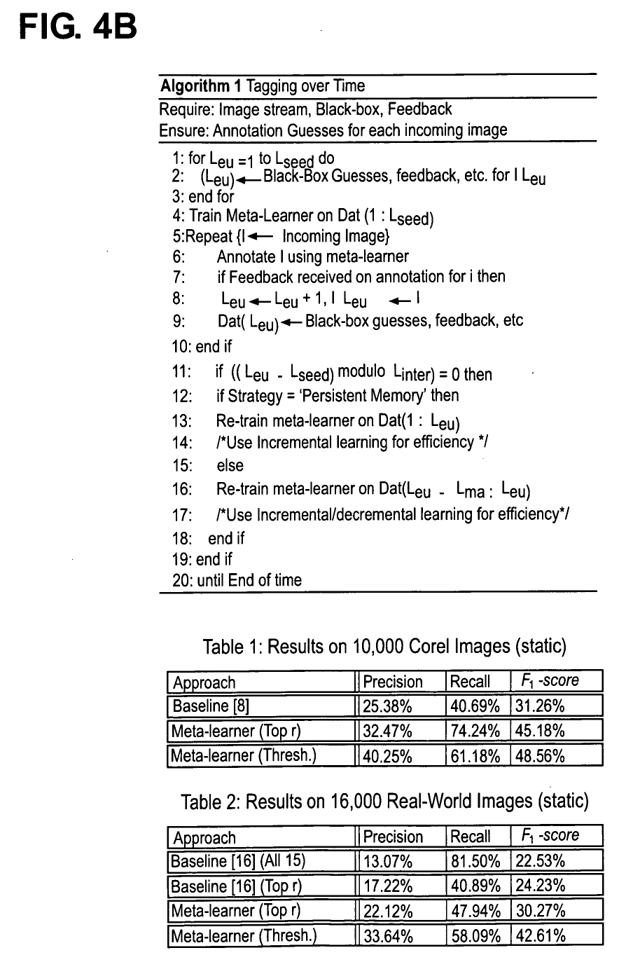

can again be justified based on ideas of inductive transfer. The following examples illustrate this:
Some visually coherent objects do not often co-occur in the same natural scene. If the black-box strongly associates orange color with the setting sun, it may often be making the mistake of labeling orange (fruit) as the sun, or vice-versa, but both occurring in the same scene may be unlikely. In this case, with wᵢ=‘oranges’ and wⱼ=‘sun’ (or vice-versa), wᵢ and wⱼ will frequently co-occur in the black-box's guesses, but in most such instances, one guess will be wrong. This will imply low values of the above ratio for this word pair, which in turn models the fact that the black-box mistakenly confuses one word for another, for visual coherence or otherwise.
Some objects that are visually coherent also frequently co-occur in natural scenes. For example, in images depicting beaches, ‘water’, and ‘sky’ often co-occur as correct tags. Since both are blue, the black-box may mistake one for the other. However, such mistakes are acceptable if both are actually correct tags for the image. In such cases, the above ratio is likely to have high values for this word pair, modeling the fact that evidence about one word reinforces belief in another, for visual coherence coupled with co-occurrence (See FIG. 3, box A). Highlighted in FIG. 3 are cases interesting from the meta-learner's viewpoint. For example, box A is read as “when ‘water’ is a correct guess, ‘sky’ is also guessed.”
For some word wⱼ, the black-box may not have effectively learned anything. This may happen due to lack of good training images, inability to capture apt visual properties, or simply the absence of the word in V_{bbox}. For example, users may be providing the word wⱼ=‘feline’ as ground-truth for images containing wᵢ=‘cat’, while only the latter may be in the black-box's vocabulary. In this case, G_{w}_{ⱼ}=0, and the ratio

$$\frac{Pr ( {G}_{{w}_{i}} = {g}_{i} \vert {A}_{{w}_{j}} = 1 , {G}_{{w}_{j}} = 0 )}{Pr ( {G}_{{w}_{i}} = {g}_{i} \vert {A}_{{w}_{j}} = 0 , {G}_{{w}_{j}} = 0 )}$$

will be high. This is a direct case of inductive transfer, where the training on one word induces guesses at another word in the vocabulary (See FIG. 3, box C). Other such scenarios where this ratio provides useful information can be conceived (See FIG. 3, box B, D). For the term

$$\frac{Pr ( {f}_{kbase} ( I ) \vert {A}_{{w}_{j}} = 1 , {⋃}_{i \neq j} ( {G}_{{w}_{i}} = {g}_{i} ) , {G}_{{w}_{j}} = {g}_{j} )}{Pr ( {f}_{kbase} ( I ) \vert {A}_{{w}_{j}} = 0 , {⋃}_{i \neq j} ( {G}_{{w}_{i}} = {g}_{i} ) , {G}_{{w}_{j}} = {g}_{j}}$$

in Eq. 5, since we deal with each word separately, the numerical abstractions ƒ_{kbase}(I) relating WordNet to the model's guesses/ground-truth can be separated out for each word (conditionally independent of other words). Therefore, we can write

$$\frac{Pr ( {f}_{kbase} ( I ) \vert - )}{Pr ( {f}_{kbase} ( I ) \vert - )} \approx \frac{Pr ( {ρ}_{j} \vert {A}_{{w}_{j}} = 1 , - )}{Pr ( {ρ}_{j} \vert {A}_{{w}_{j}} = 0 , - )} \qquad ( 8 )$$

Finally,

$$\frac{Pr ( {f}_{vis} ( I ) \vert {A}_{{w}_{j}} = 1 , {f}_{kbase} ( I ) , {⋃}_{i \neq j} ( {G}_{{w}_{i}} = {g}_{i} ) , {G}_{{w}_{j}} = {g}_{j} )}{Pr ( {f}_{vis} ( I ) \vert {A}_{{w}_{j}} = 0 , {f}_{kbase} ( I ) , {⋃}_{i \neq j} ( {G}_{{w}_{i}} = {g}_{i} ) , {G}_{{w}_{j}} = {g}_{j} )}$$

in Eq. 5 can be simplified, since ƒᵥᵢₛ(I) is the meta-learner's own visual representation ƒᵥᵢₛ(I), unrelated to the black-box's visual abstraction used for making guesses, and hence also the semantic relationship ƒ_{kbase}(1) Therefore, we re-write

$$\frac{Pr ( {f}_{vis} ( I ) \vert {A}_{{w}_{j}} = 1 , - )}{Pr ( {f}_{vis} ( I ) \vert {A}_{{w}_{j}} = 0 , - )} \approx \frac{Pr ( ( {h}_{1} , … , {h}_{D} ) \vert {A}_{{w}_{j}} = 1 )}{Pr ( ( {h}_{1} , … , {h}_{D} ) \vert {A}_{{w}_{j}} = 0 )} \qquad ( 9 )$$

which is essentially the ratio of conditional probabilities of the visual features extracted by the meta-learner, given wⱼ is correct/incorrect. A strong support for the independence assumptions made in this formulation comes from the superior experimental results. Putting everything together, and taking logarithm (monotonically increasing) to get around issues of machine precision, we can re-write Eq. 5 as a logit:

$$log {𝓁}_{{w}_{j}} ( I ) = log ( \frac{Pr ( {A}_{{w}_{j}} = 1 \vert {G}_{{w}_{j}} = {g}_{j} )}{1 - Pr ( {A}_{{w}_{j}} = 1 \vert {G}_{{w}_{j}} = {g}_{j} )} ) + {\sum }_{i \neq j} log ( \frac{Pr ( {G}_{{w}_{i}} = {g}_{i} \vert {A}_{{w}_{j}} = 1 , {G}_{{w}_{j}} = {g}_{j} )}{Pr ( {G}_{{w}_{i}} = {g}_{i} \vert {A}_{{w}_{j}} = 0 , {G}_{{w}_{j}} = {g}_{j} )} ) + log ( \frac{Pr ( {ρ}_{j} \vert {A}_{{w}_{j}} = 1 , {⋃}_{i \neq j} ( {G}_{{w}_{i}} = {g}_{i} ) , {G}_{{w}_{j}} = {g}_{j} )}{Pr ( {ρ}_{j} \vert {A}_{{w}_{j}} = 0 , {⋃}_{i \neq j} ( {G}_{{w}_{i}} = {g}_{i} ) , {G}_{{w}_{j}} = {g}_{j} )} ) + log ( \frac{Pr ( {h}_{1} , … , {h}_{D} \vert {A}_{{w}_{j}} = 1 )}{Pr ( {h}_{1} , … , {h}_{D} \vert {A}_{{w}_{j}} = 0 )} ) \qquad ( 10 )$$

This logit is used by our meta-learner for annotation, where a higher value for a word indicates a higher odds in its support, given all pertinent information. What words to eventually use as annotation for an image I can then be decided in at least two different ways, as found in the literature:
Top r: After ordering all words wⱼεV in the increasing magnitude of log l_{w}_{ⱼ}(I) to obtain a rank ordering, we annotate I using the top r ranked words.
Threshold r %: We can annotate I by thresholding at the top r percentile of the range of log l_{w}_{ᵢ}(I) values for the given image over all the words.

The formulation at this point is fairly generic, particularly with respect to harnessing of WordNet (ƒ_{kbase}(I)) and the visual representation (ƒᵥᵢₛ(I)) We now go into specifics of a particular form of these functions that we use in experiments. Furthermore we consider robustness issues that the meta-learner runs into, which is further discussed below.

### Estimation and Smoothing

The crux of the meta-learner is Eq. 10, which takes in an image I and the black-box guesses for it, and subsequently computes odds for each word. The probabilities involving A_{w}_{ⱼ} must all be estimated from any training data that may be available to the meta-learner. In a temporal setting, there will be seed training data to start with, and the estimates will be refined as and when more data/feedback becomes available. Let us consider the estimation of each term separately, given a training set of size L, consisting of images {I⁽¹⁾, . . . , I^{(L)}}, the corresponding word guesses made by the black-box, {ƒ_{bbox}(I⁽¹⁾), . . . , ƒ_{bbox}(I^{(L)})}, and the actual ground-truth/feedback, {ƒ_{gtruth}(I⁽¹⁾), . . . , ƒ_{gtruth}(I^{(L)})}. To make estimation lightweight, and thus scalable, each component of the estimation is based on empirical frequencies, and is a fully deterministic process. Moreover, this property of our model estimation makes it adaptable to incremental or decremental learning.

The probability Pr(A_{w}_{ⱼ}=|G_{w}_{ⱼ}=gⱼ) in Eq. 10 can be estimated from the size L training data as follows:

$$\hat{Pr} ( {A}_{{w}_{j}} = 1 \vert {G}_{{w}_{j}} = {g}_{j} ) = \frac{{\sum }_{n = 1}^{L} I \{ {G}_{{w}_{j}}^{( n )} = {g}_{j} \& {A}_{{w}_{j}}^{( n )} = 1 \}}{{\sum }_{n = 1}^{L} I \{ {G}_{{w}_{j}}^{( n )} = {g}_{j} \}}$$

Here, I(•) is the indicator function. A natural issue of robustness arises when the training set contains too few or no samples for G_{w}_{ⱼ}⁽ⁿ⁾=1, where estimation will be poor or impossible. Therefore, we perform a standard interpolation-based smoothing of probabilities. For this we require a prior estimate, which we compute as

$${\hat{Pr}}_{prior} ( g ) = \frac{{\sum }_{i = 1}^{K} {\sum }_{n = 1}^{L} I \{ {G}_{{w}_{i}}^{( n )} = g \& {A}_{{w}_{i}}^{( n )} = 1 \}}{{\sum }_{i = 1}^{K} {\sum }_{n = 1}^{L} I \{ {G}_{{w}_{i}}^{( n )} = g \}} \qquad ( 11 )$$

where gε{0, 1}. For g=1 (or 0), it is the estimated probability that a word that is guessed (or not guessed) is correct. The word-specific estimates are interpolated with the prior to get the final estimates as follows:

$$\tilde{Pr} ( {A}_{{w}_{j}} = 1 \vert {G}_{{w}_{j}} = {g}_{j} ) = \{ \begin{matrix}{\tilde{Pr}}_{prior} ( {g}_{j} ) & m \leq 1 ( 14 ) \\ \frac{1}{m} {\hat{Pr}}_{prior} ( {g}_{j} ) + \frac{m}{m + 1} \hat{Pr} ( {A}_{{w}_{j}} = 1 \vert {G}_{{w}_{j}} = {g}_{j} ) & m > 1\end{matrix} \qquad ( 12 )$$

where m=Σₙ₌₁^{L}I{G_{w}_{ⱼ}⁽ⁿ⁾=gⱼ}, the number of instances out of L where Wⱼ is guessed (or not guessed, depending upon gⱼ).

The probability Pr(G_{w}_{ᵢ}=gᵢ|A_{w}_{ⱼ}=1, G_{w}_{ⱼ}=gⱼ) in Eq. 10 can be estimated from the training data as follows:

$$\hat{Pr} ( {G}_{{w}_{i}} = {g}_{i} \vert {A}_{{w}_{j}} = 1 , {G}_{{w}_{j}} = {g}_{j} ) = \frac{{\sum }_{n = 1}^{L} I \{ {G}_{{w}_{i}}^{( n )} = {g}_{i} \& {G}_{{w}_{j}}^{( n )} = {g}_{j} \& {A}_{{w}_{j}}^{( n )} = 1 \}}{{\sum }_{n = 1}^{L} I \{ {G}_{{w}_{j}}^{( n )} = {g}_{j} \& {A}_{{w}_{j}}^{( n )} = 1 \}} \qquad ( 13 )$$

Here, we have a more serious robustness issue, since many word pairs may not appear in the black-box's guesses. A popular smoothing technique for word pair co-occurrence modeling is similarity-based smoothing, which is appropriate in this case, since semantic similarity based propagation of information is meaningful here. Given a WordNet-based semantic similarity measure W(wᵢ, wⱼ) between word pairs wᵢ and wⱼ, the smoothed estimates are given by:

$$\tilde{Pr} ( {G}_{{w}_{i}} = {g}_{i} \vert {A}_{{w}_{j}} = 1 , {G}_{{w}_{j}} = {g}_{j} ) = {\sum }_{k = 1}^{K} \frac{W ( {w}_{j} , {w}_{k} )}{Z} \hat{Pr} ( {G}_{{w}_{i}} = {g}_{i} \vert {A}_{{w}_{k}} = 1 , {G}_{{w}_{k}} = {g}_{k} ) \qquad ( 14 )$$

where Z is a normalization factor. When \hat{P}\hat{r}(•|•,•) cannot be estimated due to lack of samples, a prior probability estimate, computed as in the previous case, is used in its place. The Leacock and Chodorow (LCH) word similarity measure, used as W(•,•) here, generates scores between 0.37 and 3.58, higher meaning more semantically related. Thus, this procedure weighs the probability estimates for words semantically closer to wⱼ more than others.

The estimation of Pr(ρⱼ|A_{w}_{ⱼ}=a, ∪_{i≠j}(G_{w}_{ᵢ}=gᵢ),G_{w}_{ⱼ}=gⱼ), aε{0,1} in Eq. 10 will first require a suitable definition for ρj. As mentioned, it can be thought of as a numerical abstraction relating the knowledge base to the black-box's guesses. The hope here is that the distribution over this numerical abstraction will be different when certain word guesses are correct, and when they are not. One such formulation is as follows.

Suppose the black-box makes Q word guesses for an image I that has word wⱼ as a correct (or wrong) tag, for a=1 (or a=0). We model the number of these guesses, out of Q, that are semantically related to wⱼ, using the binomial distribution, which is apt for modeling counts within a bounded domain. Semantic relatedness here is determined by thresholding the LCH relatedness score W(•,•) between pairs of words (a score of 1.7, ˜50 percentile of the range, was arbitrarily chosen as threshold). Of the two binomial parameters (N, p), N is set to the number of word guesses Q made by the black-box, if it always makes a fixed number of guesses, or the maximum possible number of guesses, whichever appropriate. The parameter p is calculated from the training data as the expected value of ρⱼ for word wⱼ, normalized by N, to obtain estimates \hat{p}_{j,1} (and \hat{p}_{j,0}) for A_{w}_{ⱼ} being 1 (and 0). This follows from the fact that the expected value over a binomial PMF is N·p. Since robustness may be an issue here again, interpolation-based smoothing, using a prior estimate on p, is performed. Thus, the ratio of the binomial PMFs can be written as follows:

$$\frac{\tilde{Pr} ( {ρ}_{j} \vert {A}_{{w}_{j}} = 1 , - )}{\tilde{Pr} ( {ρ}_{j} \vert {A}_{{w}_{j}} = 0 , - )} = {( \frac{{\hat{p}}_{j , 1}}{{\hat{p}}_{j , 0}} )}^{{ρ}_{j}} {( \frac{1 - {\hat{p}}_{j , 1}}{1 - {\hat{p}}_{j , 0}} )}^{Q - {ρ}_{j}} \qquad ( 15 )$$

Finally, we discuss Pr(h₁, . . . , h_{D}|A_{w}_{ⱼ}=a), aε{0,1}, the visual representation component in Eq. 10. The idea is that the probabilistic model for a simple visual representation may differ when a certain word is correct, versus when it is not. While various feature representations are possible, we employ one that can be efficiently computed and is also suited to efficient incremental/decremental learning. Each image is divided into 16 equal partitions, by cutting along each axis into four equal parts. For each block, the RGB color values are transformed into the LUV space, and the triplet of average L, U, and V values represent that block. Thus, each image is represented by a 48-dimensional vector consisting of these triplets, concatenated in raster order of the blocks from top-left, to obtain (h₁, . . . , h₄₈). For estimation from training, each of the 48 components is fitted with a univariate Gaussian, which involves calculating the estimated mean \hat{μ}_{j,d,a} and std. dev. \hat{σ}_{j,d,a}. Smoothing is performed by interpolation with estimated priors \hat{μ} and \hat{σ}. The joint probability is computed by treating each component as conditionally independent given a word wⱼ:

$$\tilde{Pr} ( {h}_{1} , … , {h}_{D} \vert {A}_{{w}_{j}} = a ) = {\prod }_{d = 1}^{48} N ( {h}_{d} \vert {\hat{μ}}_{j , d , a} , {\hat{σ}}_{j , d , a} ) \qquad ( 16 )$$

Here, N(.) is the Gaussian PDF. So far, we have discussed the static case, where a batch of images are trained on. If ground-truth for some images is available, it can be used to train the meta-learner, to annotate the remaining ones. We experiment with this setting in Sec. 4, to see if a meta-learner built atop the black-box is advantageous or not.

### Meta-Learning Over Time

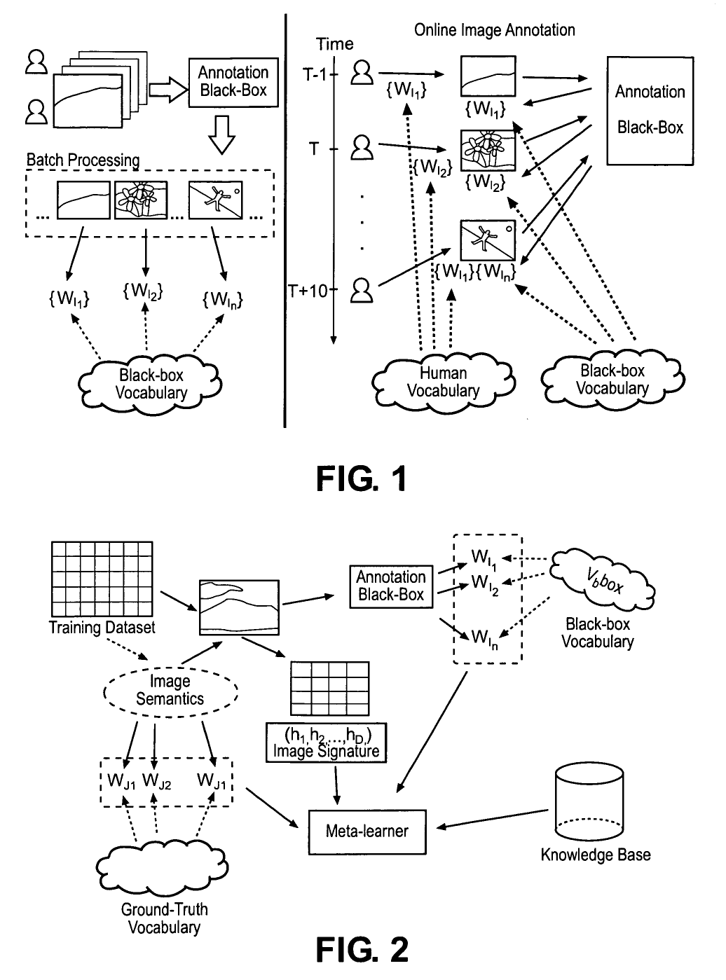

We now look at image annotation in online settings. The meta-learning framework discussed earlier has the property that the learning components involve summation of instances, followed by simple O(1) parameter estimation. Inference steps are also lightweight in nature. This makes online re-training of the meta-learner convenient via incremental/decremental learning. Imagine the online settings presented in the Background of the Invention (see FIG. 1). Here, images are annotated as they are uploaded, and whenever the users choose to provide feedback by pointing out wrong guesses, adding tags, etc. For example, in Flickr, images are publicly uploaded, and independently or collaboratively tagged, not necessarily at the time of uploading. In Alipr, feedback is solicited immediately upon uploading. In both these cases, ground-truth arrives into the system sequentially, giving an opportunity to learn from it to annotate future pictures better. Note that when we say of tagging ‘over time’, we mean tagging in sequence, temporally ordered.

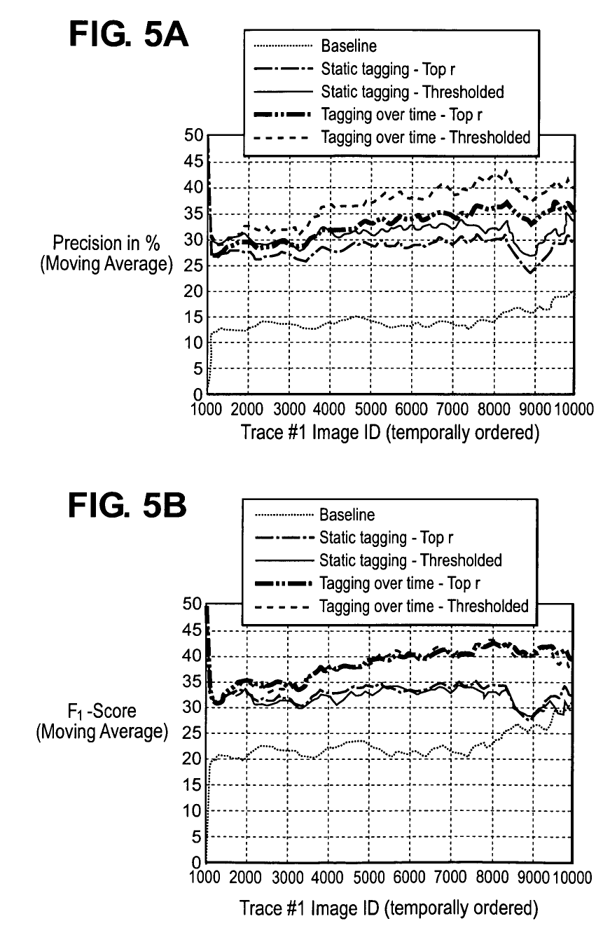

At its inception, an annotation system may not have collected any ground-truth for training the meta-learner. Hence, over a certain initial period, the meta-learner stays inactive, collecting an L_{seed} number of seed user feedback. At this point, the meta-learner is trained quickly (being lightweight), and starts annotation on incoming images. After an Lᵢₙₜₑᵣ number of new images has been received, the meta-learner is re-trained (FIG. 4 provides an overview). The primary challenge here is to make use of the models already learned, so as not to redundantly train on the same data. Re-training can be of two types depending on the underlying ‘memory model’:
Persistent Memory: Here, the meta-learner accumulates new data into the current model, so that at steps of Lᵢₙₜₑᵣ, it learns from all data since the very beginning, inclusive of the seed data. Technically, this only involves incremental learning.
Transient Memory: Here, while the model learns from new data, it also ‘forgets’ an equivalent amount of the earliest memory it has. Technically, this involves incremental and decremental learning, whereby at every Lᵢₙₜₑᵣ jump, the meta-learner is updated by (a) assimilating new data, and (b) ‘forgetting’ old data.

### Incremental/Decremental Meta-Learning

Our meta-learner formulation makes incremental and decremental learning efficient. Let us denote ranges of image sequence indices, ordered by time, using the superscript [start: end], and let the index of the current image be L_{cu}. We first discuss incremental learning, required for the case of persistent memory. Here, probabilities are re-estimated over all available data up to the current time, i.e., over [1: L_{cu}]. This is done by maintaining summations computed in the most recent re-training at lₚᵣ (say), over a range [1: Lₚᵣ] where Lₚᵣ<L_{cu}. For the first term in Eq. 10, suppressing the irrelevant variables, we can write

$$\begin{matrix}{\hat{Pr} ( {A}_{{w}_{j}} \vert {G}_{{w}_{j}} )}^{[ 1 \text{:} {L}_{cu} ]} = \frac{{\sum }_{n = 1}^{{L}_{cu}} I \{ {G}_{{w}_{j}}^{( n )} \& {A}_{{w}_{j}}^{( n )} \}}{{\sum }_{n = 1}^{{L}_{cu}} I \{ {G}_{{w}_{j}}^{( n )} \}} \\ = \frac{{S ( {G}_{{w}_{j}} \& {A}_{{w}_{j}} )}^{[ 1 \text{:} {L}_{pr} ]} + {\sum }_{n = {L}_{pr} + 1}^{{L}_{cu}} I \{ {G}_{{w}_{j}}^{( n )} \& {A}_{{w}_{j}}^{( n )} \}}{{S ( {G}_{{w}_{j}} )}^{[ 1 \text{:} {L}_{pr} ]} + {\sum }_{n = {L}_{pr} + 1}^{{L}_{cu}} I \{ {G}_{{w}_{j}}^{( n )} \}}\end{matrix} \qquad ( 17 )$$

Therefore, updating and maintaining the summation values S(G_{w}_{ᵢ}) and S(G_{w}_{ⱼ} & A_{w}_{ⱼ}) suffices to re-train the meta-learner without using time/space on past data. The priors are also computed using these summation values in a similar manner, for smoothing. Since the meta-learner is re-trained at fixed intervals of Lᵢₙₜₑᵣ, i.e., Lᵢₙₜₑᵣ=L_{cu}−Lₚᵣ only a fixed amount of time/space is required every time for getting the probability estimates, regardless of the value of L_{cu}.

The second term in Eq. 10 can also be estimated in a similar manner, by maintaining the summations, taking their quotient, and smoothing with re-estimated priors. For the third term related to WordNet, the estimation is similar, except that the summations of ρⱼ for A_{w}_{ⱼ}=0 and 1, are maintained instead of counts, to obtain estimates \hat{p}_{j,0} and \hat{p}_{j,1} respectively. For the fourth term related to visual representation, the estimated mean \hat{μ}_{j,d,a} and std.dev. \hat{σ}_{j,d,a} can also be updated with values of (h₁, . . . , h₄₈) for the new images by only storing summation values, as follows:

$${\hat{μ}}_{j , d , a}^{[ 1 \text{:} {L}_{cu} ]} = \frac{1}{{L}_{cu}} ( {S ( {h}_{d} )}^{[ 1 \text{:} {L}_{pr} ]} + {\sum }_{n = {L}_{pr} + 1}^{{L}_{cu}} {h}_{d}^{( n )} )$$

$${\hat{σ}}_{j , d , a}^{[ 1 \text{:} {L}_{cu} ]} = \sqrt{\frac{1}{{L}_{cu}} ( {S ( {h}_{d}^{2} )}^{[ 1 \text{:} {L}_{pr} ]} + {\sum }_{n = {L}_{pr} + 1}^{{L}_{cu}} {( {h}_{d}^{( n )} )}^{2} ) - {( {\hat{μ}}_{j , d , a}^{[ 1 \text{:} {L}_{cu} ]} )}^{2}}$$

owing to the fact that σ²(X)=E(X²)−(E(X))². Here, S(h_{d}²)^{[1:L}^{ₚᵣ}^{]} is the sum-of-squares of the past values of feature h_{d}, to be maintained, and E(.) denotes expectation. This justifies our simple visual representation, since it conveniently allows incremental learning by only maintaining aggregates. Overall, this process continues to re-train the meta-learner, using the past summation values, and updating them at the end, as depicted in FIG. 4.

In the transient memory model, estimates need to be made over a fixed number of recent data instances, not necessarily from the beginning. We show how this can be performed efficiently, avoiding redundancy, by a combination of incremental/decremental learning. Since every estimation process involves summation, we can again maintain summation values, but here we need to subtract the portion that is to be removed from consideration. Suppose the memory span is decided to be Lₘₛ, meaning that at the current time L_{cu}, the re-estimation must only involve data over the range [L_{cu}−Lₘₛ: L_{cu}] Let L_{old}=L_{cu}−Lₘₛ. Here, we show the re-estimation of \hat{μ}_{j,d,a}. Here, along with summation S(h_{d})^{[1:L}^{ₚᵣ}^{]}, we also require S(h_{d})^{[1:L}^{_{old}}^{-1]}. Therefore,

$${\hat{μ}}_{j , d , a}^{[ {L}_{old} \text{:} {L}_{cu} ]} = \frac{1}{{L}_{m s} + 1} {\sum }_{n = {L}_{old}}^{{L}_{cu}} {h}_{d}^{( n )} = \frac{1}{{L}_{m s} + 1} ( {S ( {h}_{d} )}^{[ 1 \text{:} {L}_{pr} ]} + {\sum }_{n = {L}_{pr} + 1}^{{L}_{cu}} {h}_{d}^{( n )} - {S ( {h}_{d} )}^{[ 1 \text{:} {L}_{old} - 1 ]} )$$

Since Lₘₛ, and Lᵢₙₜₑᵣ are decided a priori, it is straightforward to know the values of L_{old} for which S(h_{d})^{[1:L}^{_{old}}^{-1]} will be required, and we store them along the way. Other terms in Eq. 10 can be estimated similarly.

Putting things together, a high-level version of our T/T approach is presented in Algorithm 1, below. It starts with an initial training of the meta-learner using seed data of size L_{seed}. This could be accumulated online using the annotation system itself, or from an external source of images with ground-truth (e.g., Corel images). The process then takes one image at a time, annotates it, and solicits feedback. Any feedback received is stored for future meta-learning. After gaps of lᵢₙₜₑᵣ the model is re-trained based on the chosen strategy.

Algorithm 1 Tagging over Time

Require: Image stream, Black-box, Feedback
Ensure: Annotation guesses for each incoming image
1: for L_{cu} = 1 to L_{seed} do

| | |
|---|---|
| 2: | Dat(L_{cu}) ← Black-box guesses, feedback, etc. for IL_{cu} |

```
  3: end for
  4: Train meta-learner on Dat(1:L_{seed})
  5: repeat {I ← incoming image}
```

| | |
|---|---|
| 6: | Annotate I using metal-learner |
| 7: | if Feedback received on annotation for I then |

| | |
|---|---|
| | L_{cu} ← L_{cu} + 1, IL_{cu} ← I |
| 9: | Dat(L_{cu}) ← Black-box guesses, feedback, etc. |

| | |
|---|---|
| 10: | end if |
| 11: | if ((L_{cu} − L_{seed}) modulo Lᵢₙₜₑᵣ) = 0 then |

| | |
|---|---|
| 12: | if Strategy = ‘Persistent Memory’ then |

| | |
|---|---|
| 13: | Re-train meta-learner on Dat(1:L_{cu}) |
| 14: | /* Use incremental learning for efficiency * / |

| | |
|---|---|
| 15: | else |

| | |
|---|---|
| 16: | Re-train meta-learner on Dat (L_{cu} − Lₘₛ : L_{cu}) |
| 17: | /* Use incremental/decremental learning for efficiency */ |

| | |
|---|---|
| 18: | end if |

| | |
|---|---|
| 19: | end if |

20: until End of time

### Experimental Results

We perform experiments for the two scenarios shown in FIG. 1; (1) Static tagging, where a batch of images are tagged at once, and (2) Tagging over time (online setting) where images arrive in temporal order, for tagging. In the former, our meta-learning framework simple acts as a new annotation system based on an underlying black-box system. We explore whether the meta-learning layer improves performance over the black-box or not. In the latter, we have a realistic scenario that is particularly suited to online systems (Flickr, Alipr). Here, we see how the seed meta-learner fares against the black-box, and whether its performance improves with newly accumulated feedback or not. We also explore how the two meta-learning memory models, persistent and transient, fare against each other.

Experiments are performed on standard datasets and real-world data. First, we use the Corel Stock photos, to compare our meta-learning approach with the state-of-the-art. This collection of images is tagged with a 417 word vocabulary. Second, we obtain two real-world, temporally ordered traces from the Alipr system, each 10,000 in length, taken over different periods of time. Each trace consists of publicly uploaded images, the annotations provided by Alipr, and the user-feedback received on these annotations. The Alipr system provides the user with 15 guessed words (ordered by likelihoods), and the user can opt to select the correct guesses and/or add new ones. This is the feedback for our meta-learner. Here, ignoring the non-WordNet words in either vocabulary (to be able to use the WordNet similarity measure uniformly, and to reduce noise in the feedback), we have a consolidated vocabulary of 329 unique words.

Two different black-box annotation systems, which use different approaches to image tagging, are used in our experiments. A good meta-learner should fare well for different underlying black-box systems, which is what we set out to explore here. The first is Alipr, which is a real-time, online system, and the second is a recently proposed approach that was shown to outperform earlier systems. For both models, we are provided guessed tags given an image, ordered by decreasing likelihoods. Annotation performance is gauged using three standard measures, namely precision, recall and F₁-score that have been used in the past. Specifically, for each image,

$$precision = \frac{\# ( tags guessed correctly )}{\# ( tags guessed )} , \\ recall = \frac{\# ( tags guessed correctly )}{\# ( correct tags )} , and$$

$${F}_{1} \text{-} score = \frac{2 \times Precision \times Recall}{Precision + Recall}$$

(harmonic mean of precision and recall). Results reported in each case are averages over all images tested on.

The ‘lightweight’ nature of our meta-learner is validated by the fact that the re-training of each visual category in [2] and [1] are reported as 109 sec. and 106 sec. respectively. Therefore, at best, re-training will take these times when the models are built ally in parallel. In contrast, our meta-learner re-trains on 10,000 images in ˜6.5 sec. on a single machine. Furthermore, the additional computation due to the meta-learner during annotation is negligible.

### Tagging in a Static Scenario

In [1], it was reported that 24,000 Corel images, drawn from 600 image categories were used for training, and 10,000 test images were used to assess performance. We use this system as black-box by obtaining the word guesses made by it, along with the corresponding ground-truth, for each image. Our meta-learner uses an additional L_{seed}=2,000 images (randomly chosen) from the Corel dataset as the seed data. Therefore, effectively, (black-box+meta-learner) uses 26, 000 instead of 24, 000 images for training. We present results on this static case in Table I. Results for our meta-learner approach are shown for both Top r (r=5) and Threshold r % (r=60), as described elsewhere herein. The baseline results are those reported in [1]. Note the significant jump in performance with our meta-learner in both cases. Effectively, this improvement comes at the cost of only 2,000 extra images and marginal addition to computation time.

TABLE I
RESULTS ON 10,000 COREL IMAGES (STATIC)

| Approach | Precision | Recall | F₁-score |
|---|---|---|---|
| Baseline [1] | 25.38% | 40.69% | 31.26 |
| Meta-learner (Top r) | 32.47% | 74.24% | 45.18 |
| Meta-learner (Thresh.) | 40.25% | 61.18% | 48.56 |

Next, we experiment with real-world data obtained from Alipr, which we use as the black-box, and the data is treated as a batch here, to emulate a static scenario. We use both data traces consisting of 10,000 images each, the tags guessed by Alipr for them, and the user feedback on them, as described before. It turns out that most people provided feedback by selection, and a much smaller fraction typed in new tags. As a result, the recall is by default very high for the black-box system, but it also yields poor precision. For each trace, our meta-leaner is trained on L_{seed}=2,000 seed images, and tested on the remaining 8,000 images. In Table II, averaged-out results for our meta-learner approach for both Top r (r=5) and Threshold r % (r=75), as described earlier, are presented alongside the baseline performance on the same data (all 15 and top 5 guesses). Again we observe significant performance improvements over the baseline in both cases. As is intuitive, a lower percentile cut-off for threshold, or a higher number r of top words both lead to higher recall, at the cost of lower precision. Therefore, either number can be adjusted according to the specific needs of the application.

TABLE II
RESULTS ON 16,000 REAL-WORLD IMAGES (STATIC)

| Approach | Precision | Recall | F₁-score |
|---|---|---|---|
| Baseline [2] (All 15) | 13.07% | 81.50% | 22.53 |
| Baseline [2] (Top r) | 17.22% | 40.89% | 24.23 |
| Meta-learner (Top r) | 22.12% | 47.94$ | 30.27 |
| Meta-learner (Thresh.) | 33.64% | 58.09% | 42.61 |

### Tagging Over Time

We now look at the T/T case. Because the Alipr data was generated online in a real-world setting, it makes an apt test data for our T/T approach. Again, the black-box here is the Alipr system, from which we obtain the guessed tags and user feedback. The annotation performance of this system acts as a baseline for all experiments that follow.

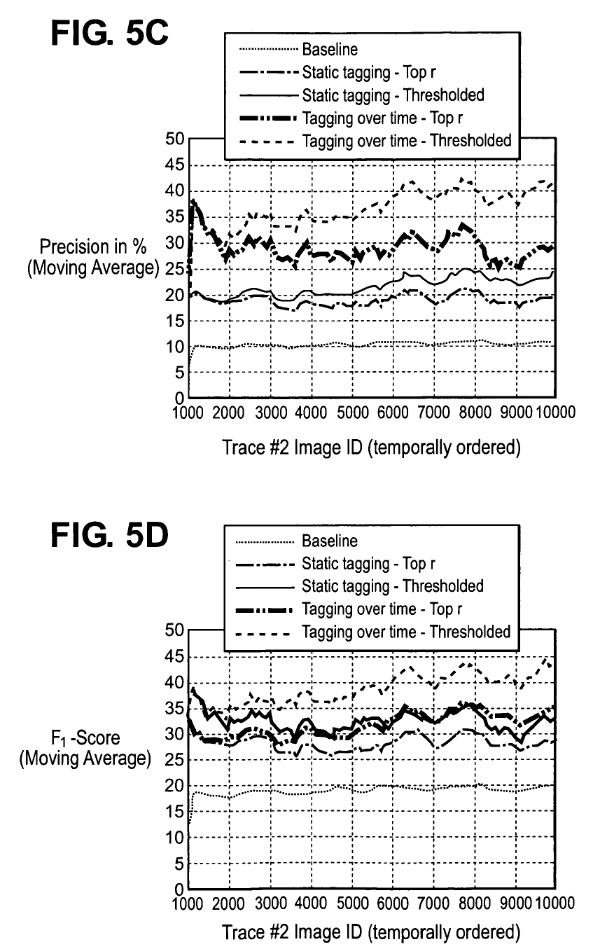

First, we experiment with the two data traces separately. For each trace, a seed data consisting of the first L_{seed}=1,000 images (in temporal order) is used to initially train the meta-learner. Re-training is performed in intervals of Lᵢₙₜₑᵣ=200. We test on the remaining 9,000 images of the trace for (a) static case, where the meta-learner is not further re-trained, and (b) T/T case, where meta-learner is re-trained over time, using (a) Top r (r=5), and (b) Threshold r % (r=75) for each case. For these experiments, the persistent memory model is used. Comparison is made using I and F₁-score, with the baseline performance being that of Alipr, the black-box. Here a comparison of recall is not interesting because it is generally high for the baseline (as explained before), and it is anyway dependent on the other two measures. These results are shown in FIGS. 5A to 5D. The scores shown are moving averages over 500 images (or less, for the initial 500 images).

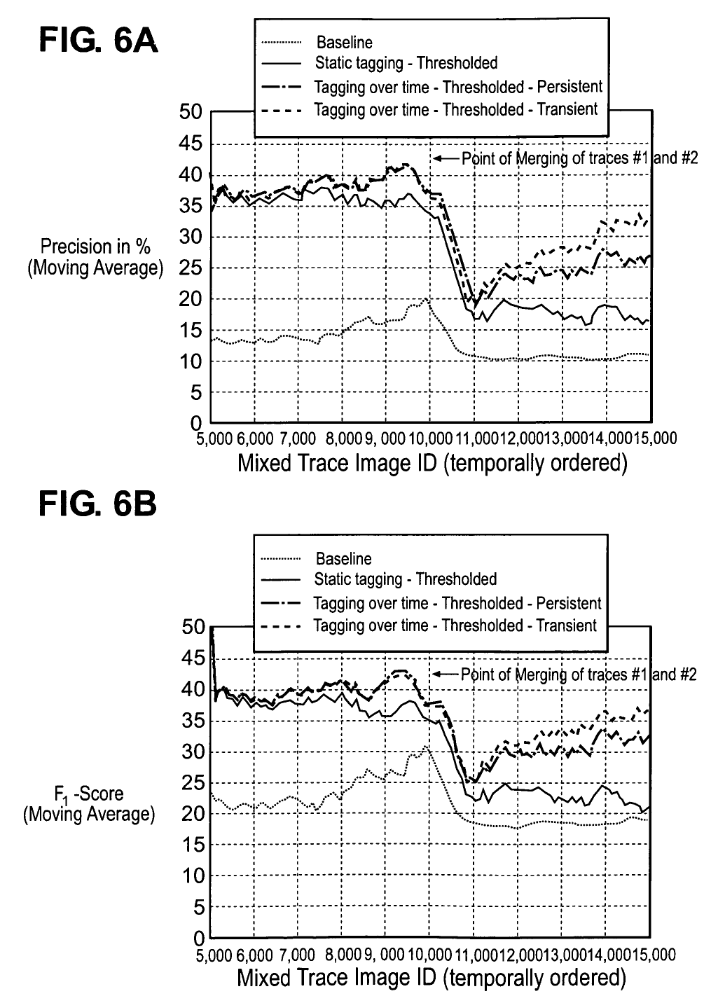

Next, we explore how the persistent and transient memory models fare against each other. The main motivation for transient learning is to ‘forget’ earlier training data that is irrelevant, due to a shift in trend in the nature of images and/or feedback. Because we observed such a shift between Alipr traces #1 and #2 (being taken over distinct time-periods), we merged them together to obtain a new 20,000 image trace to emulate a scenario of shifting trend. Performing a seed learning over images 4,001 to 5,000 (part of trace #1), we test on the trace from 5,001 to 15,000. The results for the two memory models for T/T, along with the static and baseline cases, are presented in FIGS. 6A and 6B. Note the performance dynamics around the 10,000 mark where the two traces merge. While the persistent and transient models follow each other closely till around this mark, the latter performs better after it (by up to 10%, in precision), verifying our hypothesis that under significant changes, ‘forgetting’ helps to produce a better-adapted meta-learner.

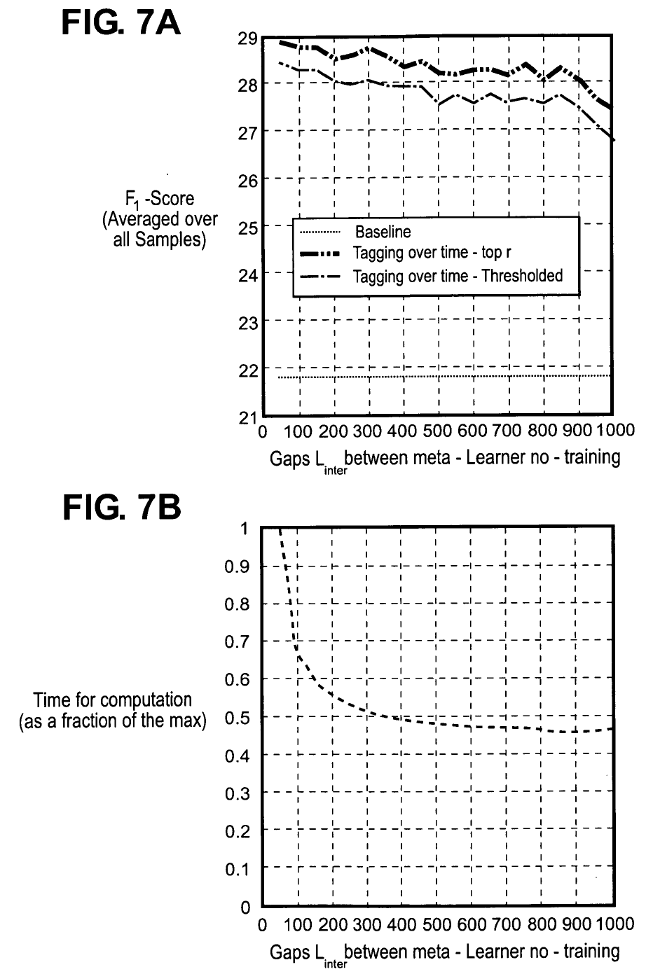

A strategic question to ask, on implementation, is ‘How often should we re-train the meta-learner, and at what cost?’. To analyze this, we experimented with the 10,000 images in Alipr trace #1, varying the interval Lᵢₙₜₑᵣ, between retraining while keeping everything else identical, and measuring the F₁-score. In each case, the computation time is noted (ignoring the latency incurred due to user waits, treated as constant here). These durations are normalized by the maximum time incurred, i.e., at Lᵢₙₜₑᵣ=100. These results are presented in FIGS. 7A and 7B. Note that with increasing gaps in re-training, F₁-score decreases to a certain extent, while computation time saturates quickly, to the amount needed exclusively for tagging. There is a clear trade-off between computational overhead and the F₁-score achieved. A graph of this nature can therefore help decide on this trade-off for a given application.

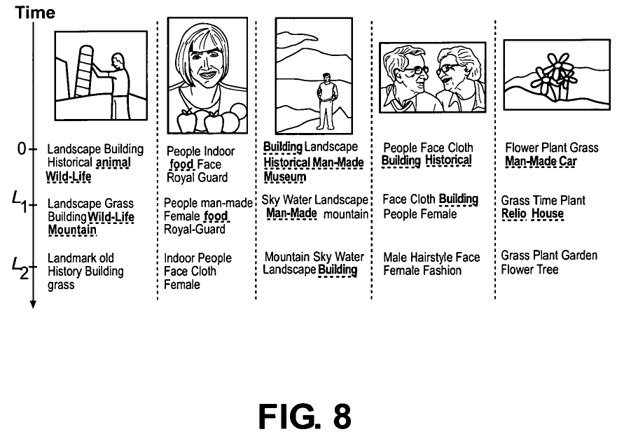

Finally, in FIG. 8, we show an image sampling from a large number of cases where we found the annotation performance to improve meaningfully with re-training over time. Specifically, against time 0 is shown the top 5 tags given to the image by Alipr, along with the meta-learner guesses after training over L₁=1000 and L₂=3000 images over time. Clearly, more correct tags are pushed up by the meta-learning process, which improves with more re-training data.

### CONCLUSIONS

In this specification, we have disclosed a principled lightweight meta-learning framework for image annotation, and through extensive experiments on two different state-of-the-art black-box annotation systems have shown that a meta-learning layer can vastly improve their performance. We have additionally disclosed a new annotation scenario which has considerable potential for real-world implementation. Taking advantage of the lightweight design of our meta-learner, we have set of a ‘tagging over time’ algorithm for efficient re-training of the meta-learner over time, as new user-feedback become available. Experimental results on standard and real-world datasets show dramatic improvements in performance. We have experimentally contrasted two memory models for meta-learner re-training. The meat-learner approach to annotation appears to have a number of attractive properties, and it seems worthwhile to implement it atop other existing systems to strengthen this conviction.

### REFERENCES

[1] R. Datta, W. Ge, J. Li J. Wang; “Toward briding the annotation-retrieval gap in image search by a generative modeling approach.” In Proc. ACM Multimedia, 2006.

[2] J. Li and J. Wang; “Real-time computerized annotation of pictures.” In Proc. ACM Multimedia 2006.

We claim:

1. A method of annotating an image, comprising the steps of:
receiving one or more annotations of an image from an existing, black box image annotation system;
providing additional annotations of the image using the annotations provided by the black box system and other available resources;
computing the probability that each additional annotation is an accurate annotation for the image; and
annotating the image using those annotations having the highest probability.

2. The method of claim 1, wherein the existing, black box image annotation system is a batch annotation system.

3. The method of claim 1, wherein the existing, black box image annotation system is an online annotation system.

4. The method of claim 1, wherein the available resources includes ground-truth annotations or tags.

5. The method of claim 1, wherein the available resources includes a semantic lexicon.

6. The method of claim 1, wherein the available resources includes the visual content of the image.

7. The method of claim 1, wherein the available resources includes the performance of the black-box system.

8. The method of claim 1, wherein the step of computing the probability that an additional annotation is accurate includes computing the probability that the annotation is an actual ground-truth tag.

9. The method of claim 1, wherein using those annotations having the highest probability includes using the top-ranked annotations.

10. The method of claim 1, wherein using those annotations having the highest probability includes thresholding the top percentile of the annotations.

11. The method of claim 1, wherein the step of providing additional annotations of the image includes guessing.

12. The method of claim 1, wherein the step of computing the probability that each additional annotation is an accurate annotation for the image includes making independent decisions with respect to each word comprising an annotation.

13. The method of claim 1, wherein the black box annotation system is an online system of the type wherein images and user tags enter the system as a temporal sequence.

14. The method of claim 1, wherein the step of providing additional annotations includes the step of providing initial training annotations.

15. The method of claim 14, wherein:
the step of providing additional annotations includes the step of providing initial training annotations; and
including the step of smoothing the computed probabilities to account for sparsity associated with available annotations.

16. The method of claim 15, wherein the step of smoothing is an interpolation-based.

17. The method of claim 15, wherein the step of smoothing is based upon similarity-based smoothing to model word pair co-occurrences.

18. The method of claim 1, further including the step of re-training following the annotation of a plurality of images.

19. The method of claim 1, wherein the re-training is based upon a persistent memory model.

20. The method of claim 1, wherein the re-training is based upon a transient memory model.
